(19) United States
(12) Patent Application Publication
(10) Pub. No.: US 2024/0126835 A1
(43) Pub. Date: Apr. 18, 2024

(54) COMPUTER-READABLE RECORDING MEDIUM STORING SAMPLING PROGRAM, SAMPLING METHOD, AND INFORMATION PROCESSING DEVICE

(71) Applicant: Fujitsu Limited, Kawasaki-shi (JP)

(72) Inventor: Yuma ICHIKAWA, Meguro (JP)

(73) Assignee: Fujitsu Limited, Kawasaki-shi (JP)

(21) Appl. No.: 18/223,054

(22) Filed: Jul. 18, 2023

(30) Foreign Application Priority Data
Oct. 12, 2022 (JP) 2022-164321

(51) Int. Cl. G06F 17/18

(52) U.S. Cl. CPC G06F 17/18

(57) ABSTRACT

A computer-readable recording medium stores a sampling program for causing a computer to execute a process. The process includes: performing sampling of a second probability distribution obtained by adding an inverse temperature parameter based on an inverse temperature that is a physical amount to a first probability distribution and training a first variational model based on first data obtained through sampling; performing sampling of a third probability distribution obtained by increasing a value of the inverse temperature parameter, by using the trained first variational model and training a second variational model based on sampled second data; and outputting a sample that corresponds to the first probability distribution, based on a result of the sampling of the third probability distribution by using the trained second variational model.

### CROSS-REFERENCE TO RELATED APPLICATION

This application is based upon and claims the benefit of priority of the prior Japanese Patent Application No. 2022-164321, filed on Oct. 12, 2022, the entire contents of which are incorporated herein by reference.

### FIELD

The embodiments discussed herein are related to a sampling program or the like for performing sampling from a probability distribution.

### BACKGROUND

Typically, sampling for obtaining a specific sample from a probability distribution that is explicitly given by a formula is used. As a method for performing sampling from the probability distribution, the Monte Carlo method has been known. Furthermore, as the Monte Carlo methods, a static Monte Carlo method for performing sampling from a probability distribution without using the Markov chain and a Markov chain Monte Carlo method (MCMC) for performing sampling from a probability distribution using the Markov chain have been known.

The MCMC that can transition to many regions in a space of a probability variable in a realistic time and can transition to a state that is different form an immediately preceding state as possible is efficient because the number of accurate and effective samples, of which an autocorrelation of a sample sequence is reduced and can be assumed to be independent, increases.

In recent years, the MCMC is applied to a statistical problem in a wide range centered on the Bayesian statistics. For example, generally analytic calculation of a many-body problem appearing in physics cannot be often performed, and it is requested to sample a state of a physical system and examine properties. Furthermore, the MCMC is used for quantum calculation simulations, which has been attracting attention recently. Furthermore, in a case where it is considered to apply data obtained through an experiment to an effective model, sampling from a posterior distribution is requested in Bayesian estimation.

Koji Hukushima and Koji Nemoto, “Exchange Monte Carlo method and application to spin glass simulations”, Journal of the Physical Society of Japan, vol. 65, no. 6, pp. 1604-1608, 1996/06/15 is disclosed as related art.

### SUMMARY

According to an aspect of the embodiments, a non-transitory computer-readable recording medium storing a sampling program for causing a computer to execute a process including: performing sampling of a second probability distribution obtained by adding an inverse temperature parameter based on an inverse temperature that is a physical amount to a first probability distribution and training a first variational model based on first data obtained through sampling; performing sampling of a third probability distribution obtained by increasing a value of the inverse temperature parameter, by using the trained first variational model and training a second variational model based on sampled second data; and outputting a sample that corresponds to the first probability distribution, based on a result of the sampling of the third probability distribution by using the trained second variational model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an information processing device according to a first embodiment;

FIG. 2 is a diagram for explaining the Metropolis method;

FIG. 3 is a diagram for explaining a problem for a specific problem;

FIG. 4 is a diagram for explaining a self-learning Monte Carlo method;

FIG. 5 is a functional block diagram illustrating a functional configuration of the information processing device according to the first embodiment;

FIG. 6 is a diagram for explaining an effect of inverse temperature expansion according to the first embodiment;

FIG. 7 is a diagram for explaining an annealing SLMC according to the first embodiment;

FIG. 8 is a flowchart for explaining a flow of processing according to the first embodiment;

FIG. 9 is a diagram for explaining a result of a numerical experiment;

FIG. 10 is a diagram for explaining the result of the numerical experiment;

FIG. 11 is a diagram for explaining interval control of the inverse temperatures by monitoring an acceptance ratio;

FIG. 12 is a diagram for explaining sequential learning of annealing;

FIG. 13 is a diagram for explaining parallel execution of an annealing process according to a second embodiment;

FIG. 14 is a diagram for explaining an application to an optimization problem; and

FIG. 15 is a diagram for explaining a hardware configuration example.

### DESCRIPTION OF EMBODIMENTS

With the known technology described above, it is not possible to perform appropriate sampling on a specific problem. For example, in case where the MCMC is performed on a multimodal distribution, a transition probability to a certain state decreases, and a transition is not substantially performed. As a result, a statistical problem is led to a wrong result. Furthermore, for the vicinity of a phase transition point, it continues to stay in a certain local space in a random variable space, and is highly dependent on an initial condition, which makes it difficult to perform appropriate sampling.

In one aspect, an object is to provide a sampling program, a sampling method, and an information processing device that can perform appropriate sampling that does not depend on a problem.

Hereinafter, embodiments of a sampling program, a sampling method, and an information processing device disclosed in the present application will be described in detail with reference to the drawings. Note that the present invention is not limited by the embodiment. Furthermore, each of the embodiments may be appropriately combined within a range without inconsistency.

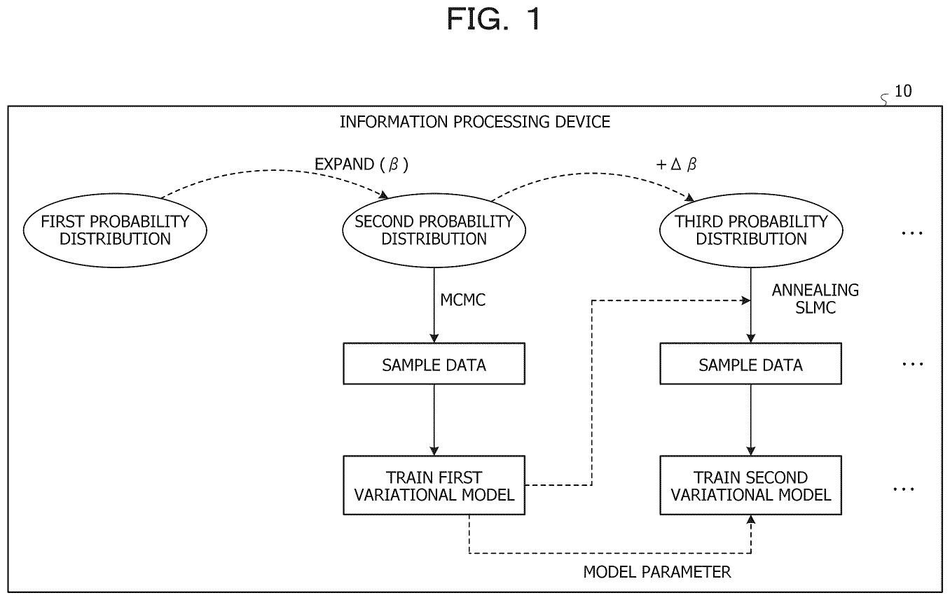

FIG. 1 is a diagram for explaining an information processing device 10 according to a first embodiment. The information processing device 10 illustrated in FIG. 1 is an example of a computer device that realizes efficient and accurate sampling from a multimodal distribution by combining the self-learning Monte Carlo method (SLMC) and an annealing process. Furthermore, the information processing device 10 realizes generation of a highly accurate variational model by training the variational model using data that has been accurately sampled.

Here, a reference technique and problems thereof will be described. In recent years, Markov chain Monte Carlo methods (MCMC) used for various statistical problems are general methods for performing sampling from a probability distribution using Markov chains. For a Markov chain that converges to a target probability distribution, a transition probability w (X′|X) from a certain state X to a state X′ needs to satisfy the following two requirements. The first one is to satisfy a balance condition indicated in Formula (1), and the second one is to represent a transition probability between arbitrary two states X and X′, not as zero, and as a product of a finite number of transition probabilities that are not zero.

[Mathematical Formula 1]

∫p(x)w(x′|x)dx=p(x′) Formula (1)

A configuration of the Markov chain that satisfies the balance condition is generally difficult, and the transition probability indicated in Formula (2) includes a detailed balance condition that is a stronger condition. As renewal rules that satisfy the detailed balance condition, the Metropolis method, the Gibbs sampling method, the hybrid Monte Carlo method (HMC), or the like have been proposed.

[Mathematical Formula 2]

p(x)w(x′|x)=p(x′)w(x|x′) Formula (2)

Here, the Metropolis method used as the MCMC that satisfies the detailed balance condition will be described. The Metropolis method executes a transition that satisfies the detailed balance condition in the following two steps. The first step generates x′ according to a proposal probability distribution g (x′|x). The second step selects x′ as a next state at an acceptance probability A (x′, x) indicated in Formula (3).

$$[ Mathematical Formula 3 ]$$

$$A ( {x}^{′} , x ) = min ( 1 , \frac{p ( {x}^{′} ) g ( x \vert {x}^{′} )}{p ( x ) g ( {x}^{′} \vert x )} ) \qquad Formula ( 3 )$$

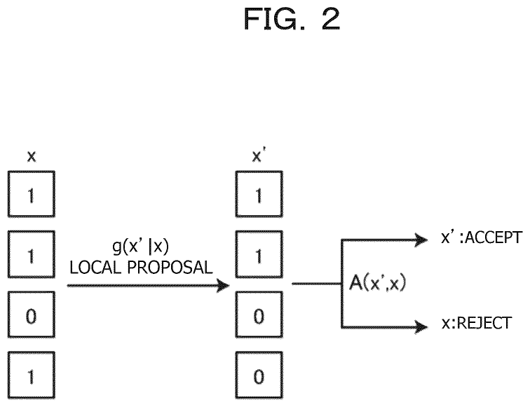

Typically, for the proposal probability distribution g (x′|x), a local proposal distribution is used. For example, in a case of a binary value, a dimension of x is randomly selected, and the value is inverted. FIG. 2 is a diagram for explaining the Metropolis method. As illustrated in FIG. 2, in a case of four-dimensional data x (1, 1, 0, 1), data x′ (1, 1, 0, 0) obtained by inverting the fourth dimension is proposed according to the proposal probability distribution g (x′|x). The proposed data x′ is accepted or rejected according to the acceptance probability A (x′, x).

However, with the MCMC using the Metropolis method or the like, it is not possible to perform appropriate sampling on a multimodal distribution or the vicinity of the phase transition point. For example, there is a case where a transition probability to a certain state decreases for a multimodal distribution, and a transition is not substantially performed, and a wrong result is obtained. Furthermore, for the vicinity of the phase transition point, it continues to stay in a certain local space in a random variable space, and is highly dependent on an initial condition, which makes appropriate sampling impossible.

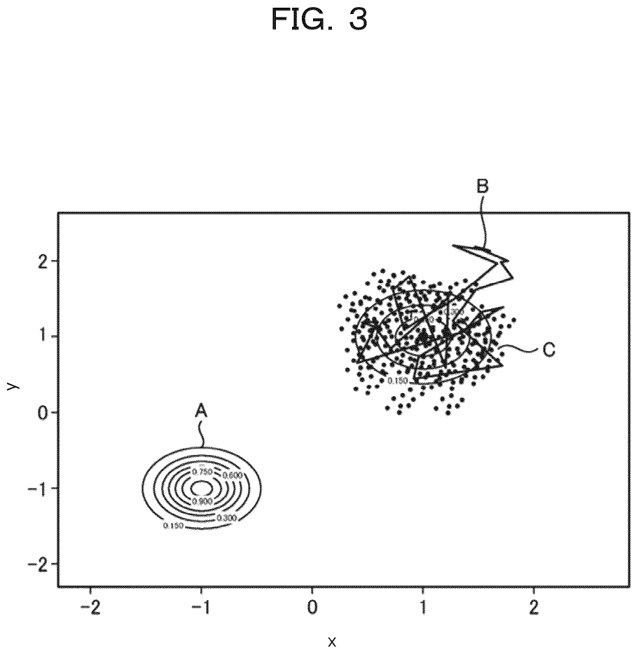

FIG. 3 is a diagram for explaining a problem for a specific problem. A illustrated in FIG. 3 represents a contour line of a two-dimensional two-component Gaussian distribution, B illustrated in FIG. 3 represents sampling data acquired by the Metropolis method with respect to the two-dimensional two-component Gaussian distribution, and C illustrated in FIG. 3 represents first 150 transitions. As illustrated in FIG. 3, with the MCMC using the Metropolis method or the like, since a transition is performed in B that is a local space, only local sampling can be performed. For example, a true average of the two-dimensional two-component Gaussian distribution is “x=0, y=0”, an average in a case where estimation is performed with a sample obtained by the Metropolis method is “x=1, y=1”. This leads a wrong result.

On the other hand, in recent years, as a technique for accelerating the MCMC using a machine learning technique, for example, the self-learning Monte Carlo method (SLMC) is used. For example, if an appropriate variational model ρ\hat{ } (x) is used for the proposal probability distribution of the Metropolis method, an acceptance probability is represented by Formula (4). Note that, in the present embodiment, “ρ\hat{ }” represents a so-called ρ hat.

$$[ Mathematical Formula 4 ]$$

$$A ( {x}^{′} , x ) = min ( 1 , \frac{p ( {x}^{′} ) \hat{p} ( x )}{p ( x ) \hat{p} ( {x}^{′} )} ) \qquad Formula ( 4 )$$

Note that, in Formula (4), in a case of ρ=ρ\hat{ }, the acceptance ratio is one. Furthermore, if a good variational model is obtained, a previous state is not referred. Therefore, a global transition can be performed, and it is possible to quantitatively evaluate quality of the variational model from the acceptance ratio.

From such a reason, the variational model (machine learning model) is trained using a sample obtained by the normal Monte Carlo method, and sampling is accelerated by using the variational model. For example, as an example of such a method, the self-learning Monte Carlo method (SLMC) is known.

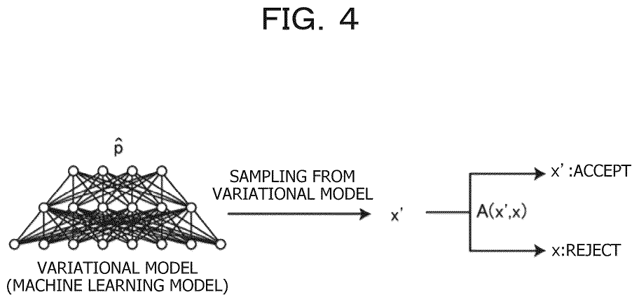

FIG. 4 is a diagram for explaining the self-learning Monte Carlo method. As illustrated in FIG. 4, the variational model is constructed by a machine learning model, and data x is extracted from the variational model through sampling. Then, the sampled data x is accepted or rejected according to a selection probability indicated in Formula (4). In this way, by using the variational model that is a machine learning model training a latent expression and trains a feature of the probability distribution, an efficient transition can be performed. For example, it is suggested that acquisition of a good latent space leads to efficiency improvement. Note that, as the variational model, a restricted Boltzmann machine, a flow-type model, a variational auto-encoder (VAE), or the like is exemplified.

However, since the SLMC is a method for training the variational model (machine learning model) using the sample obtained by a general Monte Carlo method such as the MCMC and accelerating sampling using the variational model, it is not possible to obtain an appropriate result if the sampling by the general Monte Carlo method is not appropriate.

For example, the SLMC cannot be applied to a specific probability distribution such as a multimodal distribution. For example, in a case where it is not possible to learn an accurate sample sequence (training data of variational model) of the multimodal distribution by the normal Monte Carlo method, it is not possible for the SLMC to perform accurate sampling.

Furthermore, in the SLMC, the acceptance ratio decreases when a simple solution method is used. For example, when training data is acquired from a probability distribution of an inverse temperature on which sampling can be easily performed even with a simple MCMC and the SLMC of the inverse temperature parameter β=1 is performed using the variational model of the inverse temperature, the acceptance ratio significantly decreases.

As described above, even if sampling is accelerated using the SLMC, sampling by the MCMC is not originally appropriate with respect to the specific probability distribution such as the multimodal distribution. Therefore, sampling by the SLMC is not also appropriate. For example, accuracy of sampling by the SLMC depends on a problem.

Therefore, the information processing device 10 according to the first embodiment performs appropriate sampling that does not depend on the problem by applying an annealing process similar to simulated annealing to the SLMC and widening an application range.

For example, as illustrated in FIG. 1, the information processing device 10 adds an inverse temperature parameter (β) based on an inverse temperature that is a physical amount defined by statistical mechanics, to a first probability distribution to be sampled and generates a second probability distribution that is a widened probability distribution. Then, the information processing device 10 samples data from a second probability distribution using the MCMC and performs a training of a first variational model using the sampled data.

Subsequently, the information processing device 10 increases a value of the inverse temperature parameter and generates a third probability distribution. Then, the information processing device 10 samples data from the third probability distribution, using the trained first variational model (annealing SLMC). Thereafter, the information processing device 10 performs a training of a second variational model using a model parameter of the first variational model as an initial value, using the sampled data.

Thereafter, the information processing device 10 outputs a sample corresponding to the first probability distribution, based on a result of sampling of the third probability distribution using the trained second variational model. For example, the information processing device 10 increases a value of the inverse temperature parameter to the first probability distribution that has been originally sampled and repeats the annealing SLMC described above.

In this way, the information processing device 10 repeats the generation of the probability distribution of which the value of the inverse temperature parameter is increased, sampling using the variational model that has trained the probability distribution before the increase, and training of the variational model using the sampling result. For example, the information processing device 10 introduces the annealing process into the MCMC using machine learning and performs accurate and efficient sampling on various distributions.

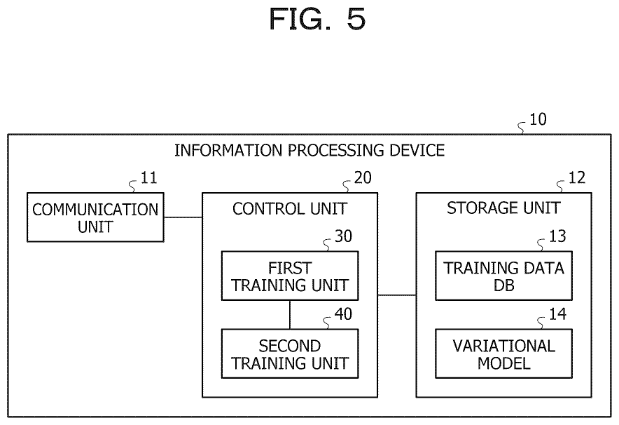

Next, a functional configuration of the information processing device 10 will be described. FIG. 5 is a functional block diagram illustrating the functional configuration of the information processing device 10 according to the first embodiment. As illustrated in FIG. 5, the information processing device 10 includes a communication unit 11, a storage unit 12, and a control unit 20.

The communication unit 11 is a processing unit that controls communication with another device. For example, the communication unit 11 transmits and receives data to and from an administrator's terminal, displays and outputs various types of data, or the like.

The storage unit 12 is a processing unit that stores various types of data, programs executed by the control unit 20, or the like. The storage unit 12 stores a training data database (DB) 13 and a variational model 14.

The training data DB 13 is a database that stores each piece of training data used to perform a training of the variational model 14. Each piece of the training data stored here is acquired through sampling by the control unit 20 to be described later.

The variational model 14 is a machine learning model to be trained. For example, as the variational model 14, a restricted Boltzmann machine, a flow-type model, a VAE, or the like can be accepted.

The control unit 20 is a processing unit that controls the entire information processing device 10 and includes a first training unit 30 and a second training unit 40. The control unit 20 outputs a sample corresponding to the target first probability distribution, by executing processing to be described later.

The first training unit 30 is a processing unit that expands a probability distribution based on an inverse temperature that is one of physical amounts, and trains the first variational model based on first data obtained by performing sampling from a probability distribution of a sufficiently small inverse temperature first. For example, the first training unit 30 performs inverse temperature expansion on the first probability distribution to be sampled, using Formula (5). For example, the first training unit 30 changes a shape of a target probability distribution, using the inverse temperature parameter (β).

$$[ Mathematical Formula 5 ]$$

$$p ( x ; β ) = \frac{{p ( x )}^{β}}{\int dx {p ( x )}^{β}} \qquad Formula ( 5 )$$

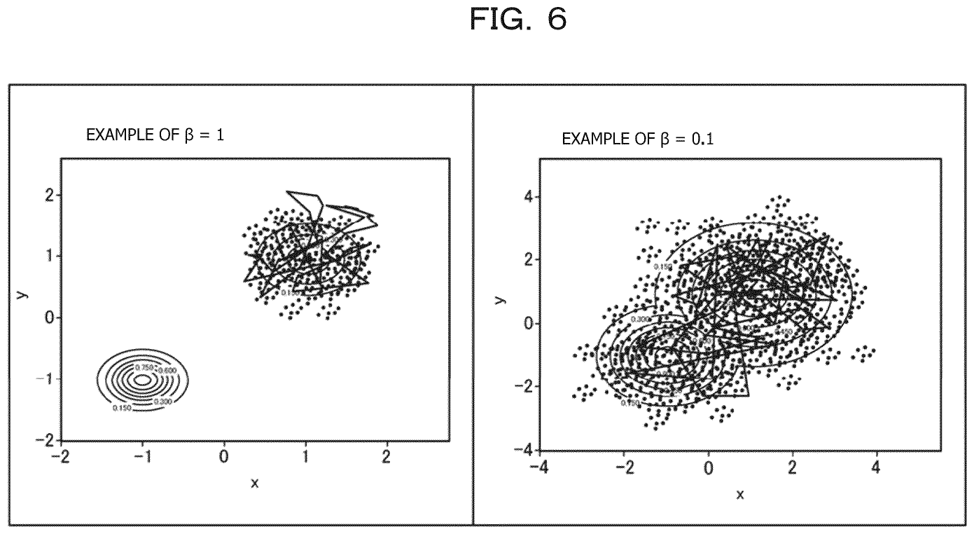

FIG. 6 is a diagram for explaining an effect of inverse temperature expansion according to the first embodiment. As illustrated in FIG. 6, in a case of β=1, since a data distribution is clustered, and this causes a multimodal distribution and makes it difficult to perform sampling. However, in a case of β=0.1, since the data distribution is not clustered, sampling is easy. In this way, in Formula (5), when β is small, sampling is typically easy. For example, the distribution becomes uniform in the limit of β→0.

For example, the first training unit 30 calculates a second probability distribution “ρ (x; β₀)” according to Formula (5) in which “β₀” that is set to be sufficiently small so as to make it easier to perform accurate sampling is assigned. Then, the first training unit 30 performs sampling on data from the second probability distribution “ρ (x; β₀)” using the MCMC and performs the training of the first variational model using each piece of the sampled data as the training data. For example, the first training unit 30 acquires a sample sequence from a distribution having sufficiently small β, using the local transition MCMC, trains a first variational model “ρ\hat{ } (x; β₀)” using the sample sequence, and stores a model parameter or the like of the trained first variational model in the storage unit 12.

The second training unit 40 is a processing unit that repeats generation of the probability distribution of which the value of the inverse temperature parameter is increased, sampling using the variational model that has trained the probability distribution, and training of the variational model using the sampling result. For example, the second training unit 40 applies the annealing process such as simulated annealing to the SLMC and performs sampling with respect to the target probability distribution.

For example, the second training unit 40 performs sampling using the variational model 14 that has trained the probability distribution “ρ (x; β)”, from a probability distribution “ρ (x; β+Δβ)” that is obtained by slightly increasing the inverse temperature parameter and performs a training of the variational model 14 using the sampled data. The second training unit 40 repeats the processing described above until “β=1” that is the distribution originally to be sampled.

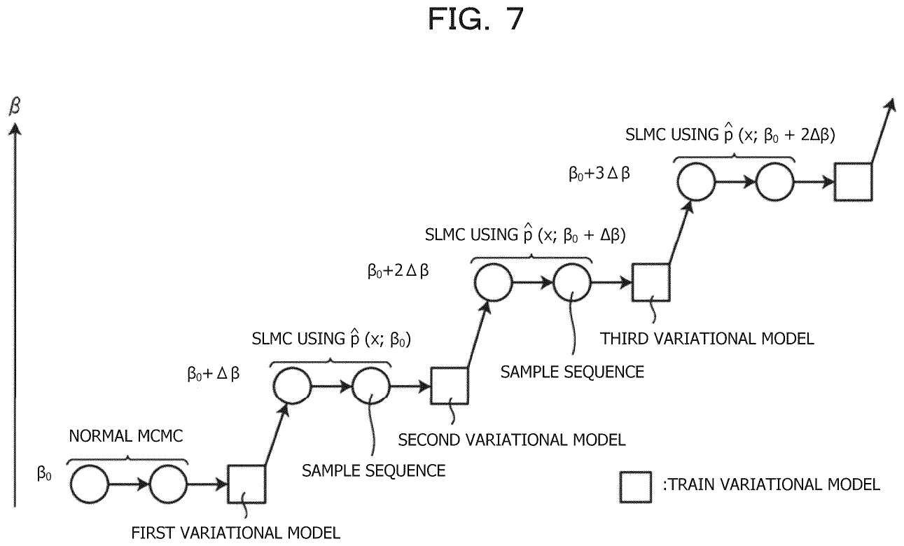

FIG. 7 is a diagram for explaining an annealing SLMC according to the first embodiment. As illustrated in FIG. 7, the second training unit 40 generates a third probability distribution “ρ (x; (β₀+Δβ)” obtained by increasing the inverse temperature parameter of the second probability distribution “ρ (x; β₀)” sampled by the first training unit 30 by a predetermined value (Δβ). Subsequently, the second training unit 40 performs sampling from the third probability distribution “ρ (x; β₀+Δβ)” by the self-learning Monte Carlo method using the first variational model “p\hat{ } (x; β₀)” that has trained the second probability distribution “ρ (x; β₀)” before the increase in the inverse temperature parameter as the proposal probability distribution. Then, the second training unit 40 performs the training of the second variational model “p\hat{ } (x; (β₀+Δβ)” using a sample sequence obtained through sampling, with a model parameter of the trained first variational model “p\hat{ } (x; β₀)” as an initial value of training.

Thereafter, the second training unit 40 generates a fourth probability distribution “ρ (x; β₀+2Δβ)” obtained by increasing the inverse temperature parameter of the third probability distribution “ρ (x; β₀+Δβ)” by a predetermined value. Subsequently, the second training unit 40 performs sampling from the fourth probability distribution “ρ (x; β₀+2Δβ)” by the self-learning Monte Carlo method using the second variational model “p\hat{ } (x; β₀+Δβ)” that has trained the third probability distribution “ρ (x; β₀+Δβ” as the proposal probability distribution. Then, the second training unit 40 performs a training of a third variational model “p\hat{ } (x; β₀+2Δβ)” using a sample sequence obtained through sampling, with a model parameter of the trained second variational model “p\hat{ } (x; β₀+Δβ” as an initial value of training.

The second training unit 40 repeats the processing described with reference to FIG. 7 until “(β₀+kΔβ)=1”. Then, the second training unit 40 performs sampling from the finally obtained probability distribution “(β₀+kΔβ)=1”, by the self-learning Monte Carlo method using the variational model that has trained the probability distribution of “(β₀+(k−1) Δβ” as the proposal probability distribution so as to realize sampling from the first probability distribution originally to be sampled.

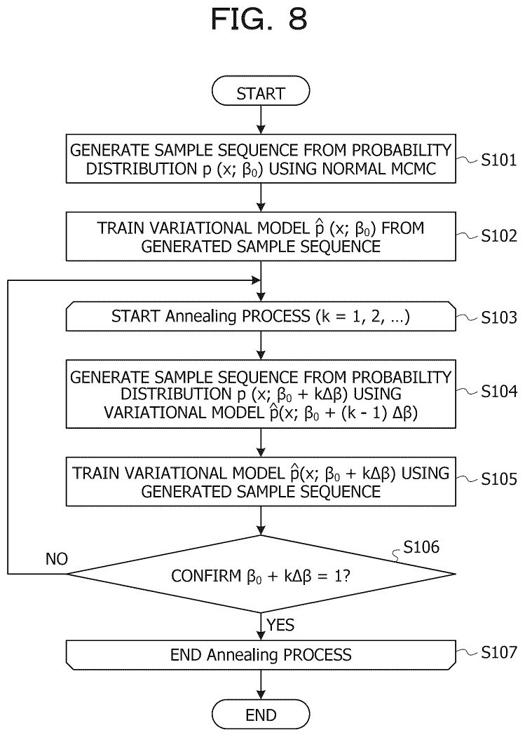

Next, a flow of processing by the control unit 20 described above will be described. FIG. 8 is a flowchart for explaining a flow of processing according to the first embodiment. As illustrated in FIG. 8, the control unit 20 of the information processing device 10 generates a sample sequence from the probability distribution “ρ (x; β₀)” obtained by expanding the probability distribution to be sampled, using a normal MCMC (S101) and trains the variational model “p\hat{ } (x; β₀)” using the generated sample sequence (S102).

Then, the control unit 20 starts annealing process from S103 to S106. For example, the control unit 20 generates a sample sequence from the probability distribution “ρ (x; β₀+kΔβ)” using the trained variational model “p\hat{ } (x; β₀+(k−1) Δβ)” (S104) and trains the variational model “p\hat{ } (x; β₀+kΔβ)” using the generated sample sequence (S105).

Thereafter, the control unit 20 confirms whether or not “(β₀+kΔβ)=1” (S106), and in a case where “(β₀+kΔβ)=1” is not satisfied (S106: No), the control unit 20 repeats S104 and subsequent steps. On the other hand, in a case where “(β₀+kΔβ)=1” is satisfied (S106: Yes), the control unit 20 ends the annealing process.

As described above, the information processing device 10 can introduce the annealing process into the MCMC using machine learning and perform accurate and efficient sampling on various distributions. Furthermore, the information processing device 10 expects that there is a common structure even if a probability distribution structure and β change, and uses, as an initial value, the model parameter of the trained variational model in a case where the variational model is trained for arbitrary k=1, 2, . . . . Therefore, the number of times of training is small, and efficient training can be performed.

Here, a result of a numerical experiment will be described. In setting of a numerical experiment, a target probability distribution is a two-component Gaussian mixture distribution, setting of an inverse temperature is divided into 10 at equal intervals within a range of “0.2 to 1.0”, a VAE has the length equal to that of the variational model, and an acquisition method acquires a sample (training data) of “β=0.2” using the Metropolis method.

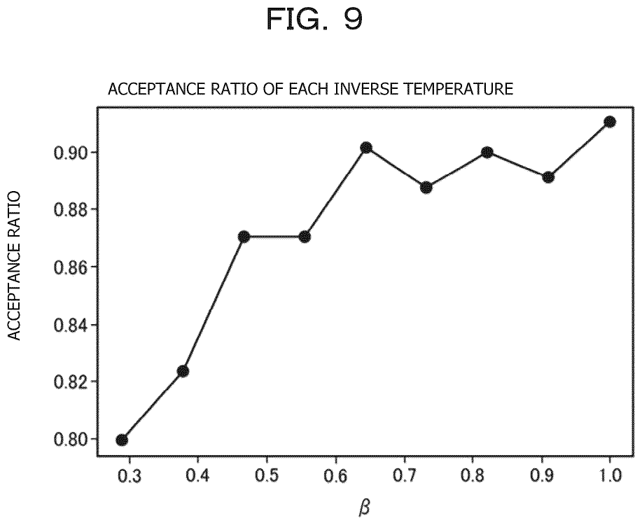

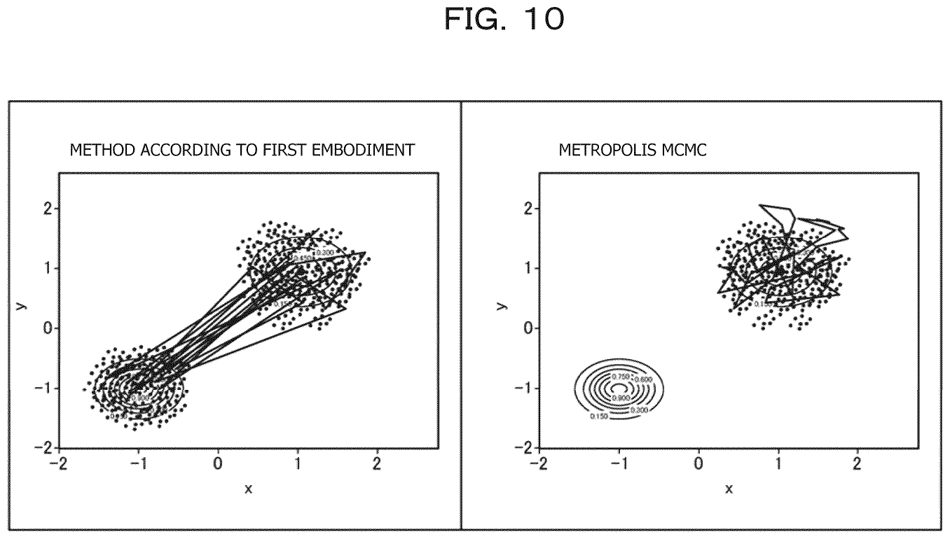

FIGS. 9 and 10 are diagrams for explaining results of numerical experiments. As illustrated in FIG. 9, it is found that the acceptance ratio increases as the inverse temperature parameter (β) increases and the acceptance ratio is typically improved by introducing the annealing process. Furthermore, as illustrated in FIG. 10, when sampling is performed using the MCMC, sampling only in a local space can be performed, and accurate sampling cannot be performed. However, it is found that, in a case where sampling is performed using the method according to the first embodiment, accurate sampling can be performed on the multimodal distribution.

Furthermore, the interval of the inverse temperature parameter described in the first embodiment does not need to be fixed and may be set as Δβ₁, Δβ₂. For example, the value of Δβ to be increased does not need to be fixed and may be a value different from the first ββ and the second Δβ. At that time, in a region where a small simulation is performed and an acceptance ratio significantly decreases, it is sufficient to shorten the interval of the inverse temperature.

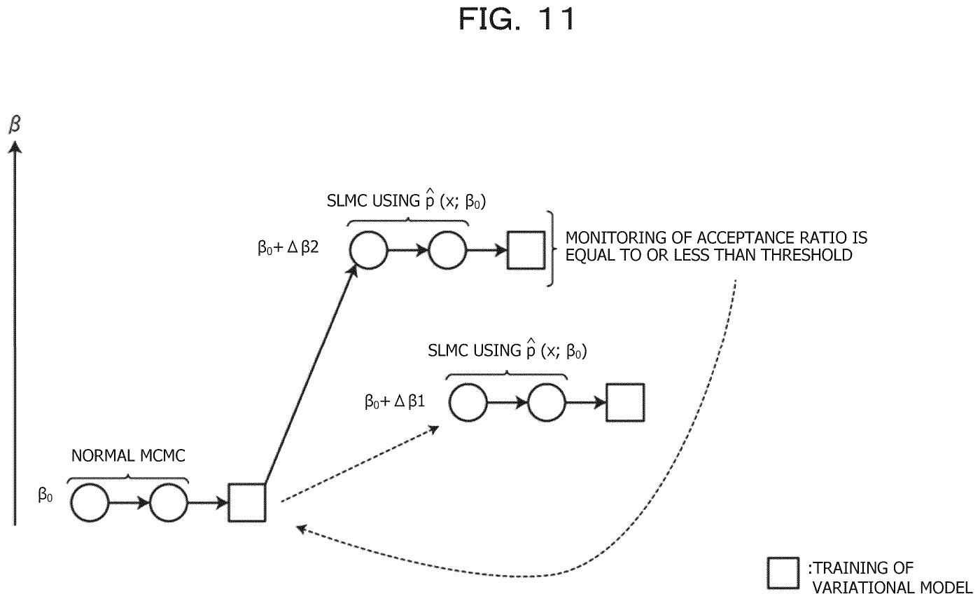

FIG. 11 is a diagram for explaining interval control of the inverse temperature by monitoring the acceptance ratio. As illustrated in FIG. 11, the information processing device 10 performs sampling by the self-learning Monte Carlo method using the first variational model “ρ\hat{ } (x; β₀)” that has trained the second probability distribution “ρ (x; β₀)”, from the third probability distribution “ρ (x; β₀+Δβ2)” obtained by increasing the inverse temperature parameter of the second probability distribution “ρ (x; β₀)”, as the proposal probability distribution.

At this time, the information processing device 10 monitors the acceptance ratio and, in a case where the acceptance ratio is equal to or less than a threshold, the information processing device 10 decreases the inverse temperature parameter. For example, the information processing device 10 generates a new third probability distribution “ρ (x; β₀+Δβ1)” using Δβ1 smaller than Δβ2 and performs sampling from the new third probability distribution “p (x; β₀+Δβ1)” by the self-learning Monte Carlo method using the first variational model “p\hat{ } (x; β₀)” that has trained the second probability distribution “ρ (x; β₀)” as the proposal probability distribution.

In this way, since the information processing device 10 can monitor the decrease in the acceptance ratio and dynamically change the inverse temperature parameter, it is possible to shorten a training time of the variational model and suppress a decrease in the accuracy of the variational model.

Furthermore, the information processing device 10 described in the first embodiment can perform a simulation while monitoring the acceptance ratio and can perform sequential learning. For example, in a case where the acceptance ratio is low, the information processing device 10 can perform sampling on a distribution “ρ (x; β+kΔβ)” using a variational model “ρ\hat{ } (x; β+kΔβ)” during annealing and can train the variational model “ρ\hat{ } (x; β+kΔβ)” again using the sample sequence.

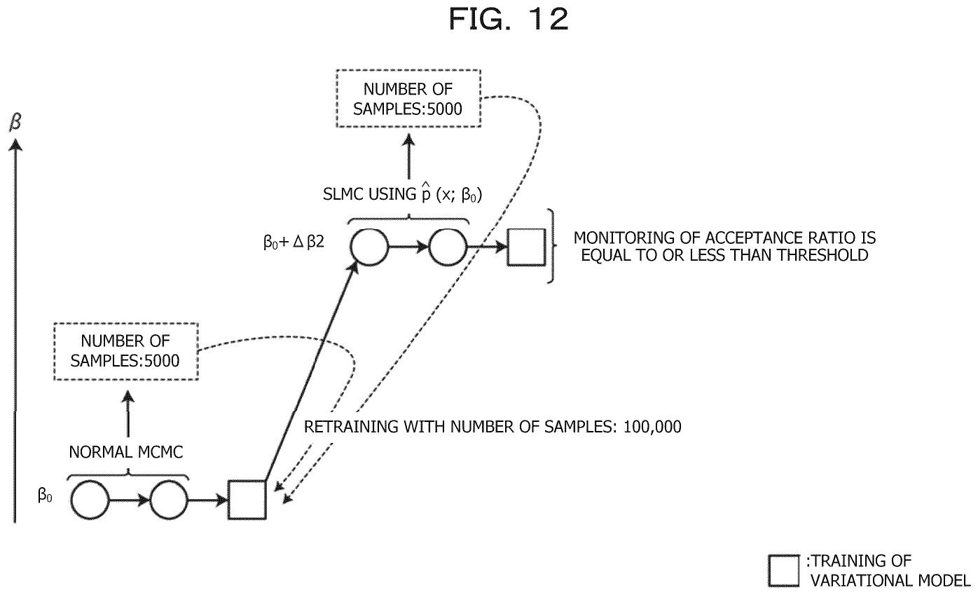

FIG. 12 is a diagram for explaining sequential learning of annealing. As illustrated in FIG. 12, the information processing device 10 performs sampling by the self-learning Monte Carlo method using the first variational model “ρ\hat{ } (x; β₀)” that has trained the second probability distribution “ρ (x; β0)”, from the third probability distribution “ρ (x; β₀+Δβ2)” obtained by increasing the inverse temperature parameter of the second probability distribution “ρ (x; β₀)”, as the proposal probability distribution.

At this time, the information processing device 10 monitors the acceptance ratio and, in a case where the acceptance ratio is equal to or less than a threshold, the information processing device 10 performs sequential learning. For example, the information processing device 10 performs sampling on, for example, 5,000 pieces of data, by the self-learning Monte Carlo method using the first variational model “ρ\hat{ } (x; β₀)” that has trained the second probability distribution “ρ (x; β₀)” from the third probability distribution “ρ (x; β₀+Δβ2)”, as the proposal probability distribution. Furthermore, the information processing device 10 performs sampling on, for example, 5,000 pieces of data, by the self-learning Monte Carlo method using the first variational model “ρ\hat{ } (x; β₀)” that has trained the second probability distribution “ρ (x; β₀)” from the second probability distribution “ρ (x; β₀)”, as the proposal probability distribution.

Then, the information processing device 10 trains the first variational model “ρ\hat{ } (x; β₀)” again, using the 5,000 pieces of data sampled from the second probability distribution “ρ (x; β₀)” and the 5,000 pieces of data sampled from the third probability distribution “ρ (x; β₀+Δβ2)”. After the completion of retraining, the information processing device 10 performs sampling by the self-learning Monte Carlo method using the first variational model “ρ\hat{ } (x; β₀)” retrained from the third probability distribution “ρ (x; β₀+Δβ2)” as the proposal probability distribution and performs the training of the second variational model “ρ\hat{ } (x; β₀Δβ2)” using the sample sequence.

In this way, since the information processing device 10 can monitor the decrease in the acceptance ratio and perform sequential learning, even in a case where the acceptance ratio decreases, the information processing device 10 can control the synchronous inverse temperature parameter so as to improve the acceptance ratio.

By the way, the information processing device 10 described above can perform the annealing process described above in parallel. Therefore, in a second embodiment, an example will be described in which the annealing process is performed in parallel.

For example, an information processing device 10 according to the second embodiment performs the annealing process while performing parallelization at different inverse temperatures (β₁, . . . , βₖ). For example, the information processing device 10 uses a transition used for a replica exchange Monte Carlo method in which exchange is performed at a probability indicated in Formula (6), between different temperatures. In Formula (6), a probability is indicated at which inverse temperature parameters βₖ and βₖ₊₁ randomly selected for each appropriate step number are exchanged.

$$[ Mathematical Formula 6 ]$$

$$min ( 1 , \frac{p ( {x}_{k + 1} ; {β}_{k} ) p ( {x}_{k} ; {β}_{k + 1} )}{p ( {x}_{k} ; {β}_{k} ) p ( {x}_{k + 1} \vert {β}_{k} )} ) \qquad Formula ( 6 )$$

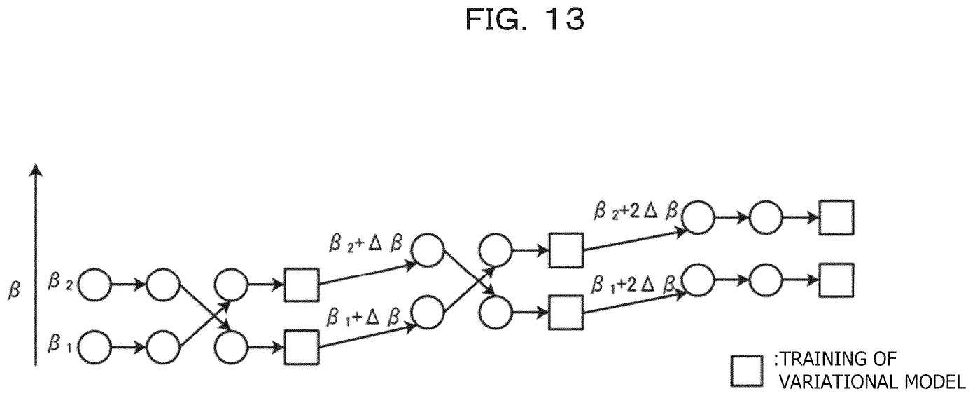

FIG. 13 is a diagram for explaining parallel execution of an annealing process according to the second embodiment. As illustrated in FIG. 13, the information processing device 10 performs sampling on first data by the MCMC, from a probability distribution “ρ (x; β₁)” and performs sampling on second data by the MCMC from a probability distribution “ρ (x; β₂)”.

Then, the information processing device 10 performs a training of a variational model “ρ\hat{ } (x; β₂)”, using the first data sampled from the probability distribution “ρ (x; β₁)”. On the other hand, a training of a variational model “p\hat{ } (x; β₁)” is performed using the second data sampled from the probability distribution “ρ (x; β₂)”.

Thereafter, the information processing device 10 performs sampling on third data using the trained variational model “ρ\hat{ } (x; β₁)” from a probability distribution “ρ (x; β₁+Δβ)”. On the other hand, the information processing device 10 performs sampling on fourth data using the trained variational model “ρ\hat{ } (x; β₂)” from a probability distribution “ρ (x; β₂+Δβ)”.

Then, the information processing device 10 performs a training of a variational model “ρ\hat{ } (x; β₂+Δβ)”, using the third data sampled from the probability distribution “ρ (x; β₁+Δβ)”. On the other hand, a training of a variational model “ρ\hat{ } (x; β₁+Δβ)” is performed, using the fourth data sampled from the probability distribution “ρ (x; β₂+Δβ)”.

As a result, the information processing device 10 can efficiently acquire accurate training data having a small autocorrelation. Furthermore, since it is sufficient that the largest “βₖ” reach “βₖ=1”, the information processing device 10 can reduce a temperature interval of annealing. Note that, for a setting interval (Δβ) of each inverse temperature parameter, a different value can be set. Furthermore, for βₖ and Δβₖ, a preliminary simulation is performed, and a value that has an appropriate exchange frequency can be set.

By the way, the probability distribution of “β→∞” described in the first embodiment or the second embodiment described above becomes a uniform distribution of an optimal solution. Therefore, the information processing device 10 described above can apply the annealing process to an optimization problem.

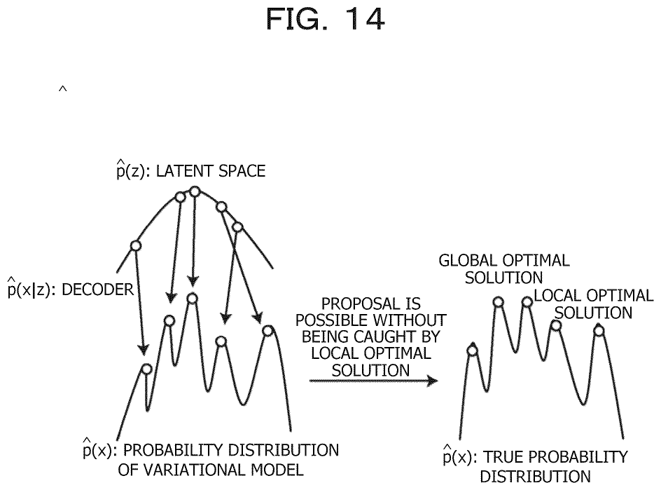

FIG. 14 is a diagram for explaining application to the optimization problem. As illustrated in FIG. 14, the information processing device 10 performs the annealing process to a sufficiently large β according to the first embodiment or the second embodiment. At this time, in a model having a latent variable, an important mode is contracted to a single latent variable. Furthermore, by using a variational model that has a latent variable and that is easily sampled (β is large), the information processing device 10 can easily transition (move back and forth) to a local optimal solution.

For example, by using a VAE or a flow-based model as the variational model, the information processing device 10 can perform sampling on a latent variable from a latent variable distribution that can be easily sampled and can perform exchange, and easily propose a plurality of candidates at the same time.

The data examples, numerical value examples, thresholds, the number of samples, specific examples, or the like used in the embodiment described above are merely examples, and may be arbitrarily changed. Pieces of information including the processing procedure, control procedure, specific name, various types of data and each parameter described above or illustrated in the drawings may be arbitrarily changed unless otherwise noted.

Furthermore, each component of each device illustrated in the drawings is functionally conceptual, and does not necessarily have to be physically configured as illustrated in the drawings. For example, specific forms of distribution and integration of the devices are not limited to those illustrated in the drawings. For example, all or a part thereof may be configured by being functionally or physically distributed or integrated in optional units according to various types of loads, usage situations, or the like.

Moreover, all or some of the processing functions performed in each device may be implemented by a central processing unit (CPU) and a program analyzed and executed by the CPU, or may be implemented as hardware by wired logic.

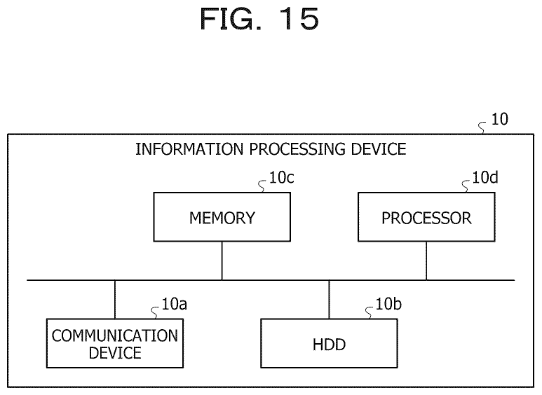

FIG. 15 is a diagram for explaining a hardware configuration example. As illustrated in FIG. 15, the information processing device 10 includes a communication device 10a, a hard disk drive (HDD) 10b, a memory 10c, and a processor 10d. Furthermore, the units illustrated in FIG. 15 are mutually coupled by a bus or the like.

The communication device 10a is a network interface card or the like and communicates with another device. The HDD 10b stores programs that operate the functions illustrated in FIG. 5 and DBs.

The processor 10d reads a program that executes processing similar to the processing of each processing unit illustrated in FIG. 5 from the HDD 10b or the like and loads the read program into the memory 10c, thereby operating a process that executes each function described with reference to FIG. 5 or the like. For example, this process executes a function similar to that of each processing unit included in the information processing device 10. For example, the processor 10d reads, from the HDD 10b or the like, a program having a function similar to that of the first training unit 30, the second training unit 40, or the like. Then, the processor 10d executes a process that executes processing similar to that of the first training unit 30, the second training unit 40, or the like.

As described above, the information processing device 10 is activated as an information processing device that executes a machine learning method by reading and executing a program. In addition, the information processing device 10 may also implement functions similar to the functions of the above-described embodiments by reading the above program from a recording medium by a medium reading device and executing the above program that has been read. Note that other programs referred to in the embodiments are not limited to being executed by the information processing device 10. For example, the embodiment may be similarly applied to a case where another computer or server executes the program, or a case where these cooperatively execute the program.

This program may be distributed via a network such as the Internet. Furthermore, this program may be recorded in a computer-readable recording medium such as a hard disk, flexible disk (FD), compact disc read only memory (CD-ROM), magneto-optical disk (MO), or digital versatile disc (DVD), and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a sampling program for causing a computer to execute a process comprising:
performing sampling of a second probability distribution obtained by adding an inverse temperature parameter based on an inverse temperature that is a physical amount to a first probability distribution and training a first variational model based on first data obtained through sampling;
performing sampling of a third probability distribution obtained by increasing a value of the inverse temperature parameter, by using the trained first variational model and training a second variational model based on sampled second data; and
outputting a sample that corresponds to the first probability distribution, based on a result of the sampling of the third probability distribution by using the trained second variational model.

2. The non-transitory computer-readable recording medium according to claim 1, wherein in the training of the second variational model,
setting a model parameter of the trained first variational model as an initial value and training the second variational model by using the second data.

3. The non-transitory computer-readable recording medium according to claim 2,
wherein in the training of the first variational model, acquiring the first data from the second probability distribution through sampling by using the Monte Carlo method and training the first variational model that trains the first probability distribution based on the first data, and
wherein in the training of the second variational model, sampling on the second data from the third probability distribution, by a self-learning Monte Carlo method that uses the trained first variational model as a proposal probability distribution and training the second variational model that trains the third probability distribution, based on the second data.

4. The non-transitory computer-readable recording medium according to claim 1, the process further comprising:
generating two different probability distributions obtained by adding each of two different inverse temperature parameters based on the inverse temperature to the first probability distribution; and
performing, by using data sampled from one probability distribution, a training of a variational model based on another probability distribution and performing, by using data sampled from the another probability distribution, a training a variational model based on the one probability distribution.

5. The non-transitory computer-readable recording medium according to claim 1, the process further comprising:
performing sampling by using a trained variational model trained by using sampled data from a probability distribution, from an expanded probability distribution obtained by adding an inverse temperature parameter based on the inverse temperature to the probability distribution and performing a training of a variational model that trains the expanded probability distribution by using the sampled data;
repeating the processing of performing the training until the increased value of the inverse temperature parameter reaches a predetermined value while increasing the value of the inverse temperature parameter; and
outputting data obtained by performing sampling by using the trained variational model that has trained an immediately preceding probability distribution, from the expanded probability distribution obtained by increasing the value of the inverse temperature parameter that is the predetermined value as an optimum solution of the probability distribution, after the processing of repeating has been completed.

6. A computer-performed sampling method comprising:
performing sampling of a second probability distribution obtained by adding an inverse temperature parameter based on an inverse temperature that is a physical amount to a first probability distribution and training a first variational model based on first data obtained through sampling;
performing sampling of a third probability distribution obtained by increasing a value of the inverse temperature parameter, by using the trained first variational model and training a second variational model based on sampled second data; and
outputting a sample that corresponds to the first probability distribution, based on a result of the sampling of the third probability distribution by using the trained second variational model.

7. An information processing apparatus comprising:
a memory, and
a processor coupled to the memory and configured to:
perform sampling of a second probability distribution obtained by adding an inverse temperature parameter based on an inverse temperature that is a physical amount to a first probability distribution and training a first variational model based on first data obtained through sampling;
perform sampling of a third probability distribution obtained by increasing a value of the inverse temperature parameter, by using the trained first variational model and training a second variational model based on sampled second data; and
output a sample that corresponds to the first probability distribution, based on a result of the sampling of the third probability distribution by using the trained second variational model.
